(19) United States
(12) Patent Application Publication
(10) Pub. No.: US 2011/0280247 A1
(43) Pub. Date: Nov. 17, 2011

(54) SYSTEM AND METHOD FOR REDUCING LATENCY VIA MULTIPLE NETWORK CONNECTIONS

(75) Inventor: James Roskind, Redwood City, CA (US)

(73) Assignee: GOOGLE INC., Mountain View, CA (US)

(21) Appl. No.: 12/781,185

(22) Filed: May 17, 2010

(51) Int. Cl. H04L 12/56

(52) U.S. Cl. 370/401

(57) ABSTRACT

A system and method is provided whereby more requests than are necessary to obtain a network resource may be adaptively determined and preemptively transmitted from a client device to a server device in order to reduce latency caused by the delay or loss of a request. In one aspect, the system and method includes transmitting multiple connection requests from the client to the server, where the number of the connection requests transmitted to the server is greater than the number necessary to obtain a resource hosted by the server.

### BACKGROUND OF THE INVENTION

The Internet protocol suite is a well known and widely used suite of protocols for servicing data transmissions between two devices communicating information over the Internet. In particular, the Transmission Control Protocol or TCP is a part of the Internet protocol suite that provides for connection-oriented, reliable, and ordered delivery of a stream of data packets between, for example, a web-browser application running on a client device and a web-server application running on a server device over a local or wide area network.

To communicate with a server device using the TCP protocol, a client device must first establish a TCP connection with the server. Establishing a TCP connection requires an exchange of three specific messages (i.e., data packets) between the client device and the server device, a mechanism sometimes referred to as a three-way handshake.

In accordance with the three-way handshake mechanism, a client device that wants to communicate with the server by sending or receiving information initiates the handshake by transmitting a SYN packet (first message) requesting a connection to the server. Upon receiving the SYN packet, the server device responds to the client's connection request by transmitting a SYN-ACK packet (second message) back to the client that serves as an acknowledgement of the client's request and provides additional details regarding the requested connection, such as port information associated with the connection request. Finally, the client device transmits an ACK packet (third and last message) to the server acknowledging the receipt of the SYN-ACK packet and the information therein.

A connection between the client device and the server device is established upon successful completion of the three-way handshake, and each device may transmit information (i.e., data packets) to the other device using the established connection. For example, the client device may use the established connection to request and obtain a web-page or other resources hosted by the server over the connection.

### BRIEF SUMMARY OF THE INVENTION

In one aspect, a method of transmitting a request over a network is provided. The method includes: receiving a resource request at an initiation node for a desired resource hosted at a destination node; adaptively determining and preemptively transmitting a plurality of connection requests from the initiation node to the destination node to obtain the desired resource; establishing, in accordance with a network protocol, one or more connections between the initiation node and the destination node, where the one or more connections is established based on respective response packets received from the destination node in response to the one or more of the preemptively transmitted plurality of connection request packets, and where the one or more established connections including a first established connection established prior to any other established connections; automatically selecting, at the initiation node, the first established connection to the destination node and adding the first established connection to a pool of usable connections; and, transmitting the resource request to the destination node via the first established connection.

In another aspect, a method of transmitting data over a network is provided. The method includes: receiving a resource request at an initiation node for a desired resource hosted at a destination node; transmitting a first request from the initiation node to the destination node over the network, to obtain the desired resource; defining a timeout window with a processor at the initiation node, where the timeout window is associated with the transmission of the first request and a maximum timeframe in accordance with a network protocol for receiving a first reply from the destination node responsive to the first request; and, preemptively transmitting from the initiation node to the destination node over the network, at least one additional request to obtain the desired resource, where the at least one additional request is transmitted to the destination prior to receiving the first reply at the initiation node and prior to expiration of the maximum timeframe set by the timeout window.

In a further aspect, a system for transmitting data over a network is provided, the system including: a memory storing instructions and data and a processor to execute the instructions and to process the data, where the data includes a resource request for a desired resource hosted at a destination node, and where the instructions include: adaptively determining and preemptively transmitting a plurality of connection requests from the initiation node to the destination node to obtain the desired resource; establishing, in accordance with a network protocol, one or more connections between the initiation node and the destination node, where the one or more connections is established based on respective response packets received from the destination node in response to the one or more of the preemptively transmitted plurality of connection request packets, and where the one or more established connections including a first established connection established prior to any other established connections; automatically selecting, at the initiation node, the first established connection to the destination node and adding the first established connection to a pool of usable connections; and, transmitting the resource request to the destination node via the first established connection.

In a yet another aspect, a system for transmitting data over a network is provided, the system including: a memory storing instructions and data and a processor to execute the instructions and to process the data, where the data includes a resource request for a desired resource hosted at a destination node, and where the instructions include: transmitting a first request from the initiation node to the destination node over the network to obtain the desired resource; defining a timeout window with a processor at the initiation node, where the timeout window is associated with the transmission of the first request and a maximum timeframe in accordance with a network protocol for receiving a first reply from the destination node responsive to the first request; and, preemptively transmitting from the initiation node to the destination node over the network, at least one additional request to obtain the desired resource, where the at least one additional request is transmitted to the destination prior to receiving the first reply at the initiation node and prior to expiration of the maximum timeframe set by the timeout window.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a block diagram of an exemplary embodiment of the system of FIG. 2.

FIG. 2 is a block diagram of a system in accordance with an aspect of the present invention.

FIGS. 3-10 illustrate an exemplary operation in accordance with one aspect of the present invention.

FIG. 11 illustrates an exemplary operation in accordance with another aspect of the present invention.

FIG. 12 is a flow diagram of a process in accordance with one aspect of the present invention.

### DETAILED DESCRIPTION

In one aspect, a system and method is provided whereby latency between an initiating device and a destination device, such as but not limited to a client and a server exchanging information over a network, is reduced by preemptively transmitting an adaptively determined plurality of requests from the client to the server to obtain a resource hosted at the server. In accordance with this aspect, the adaptively determined number of the requests preemptively transmitted to the server (i.e., the number of requests that are transmitted independent of a response from the server to any single request and prior to any retransmission of an original request as provided for by conventional networking protocols), may be greater than the number necessary to obtain the resource from the server.

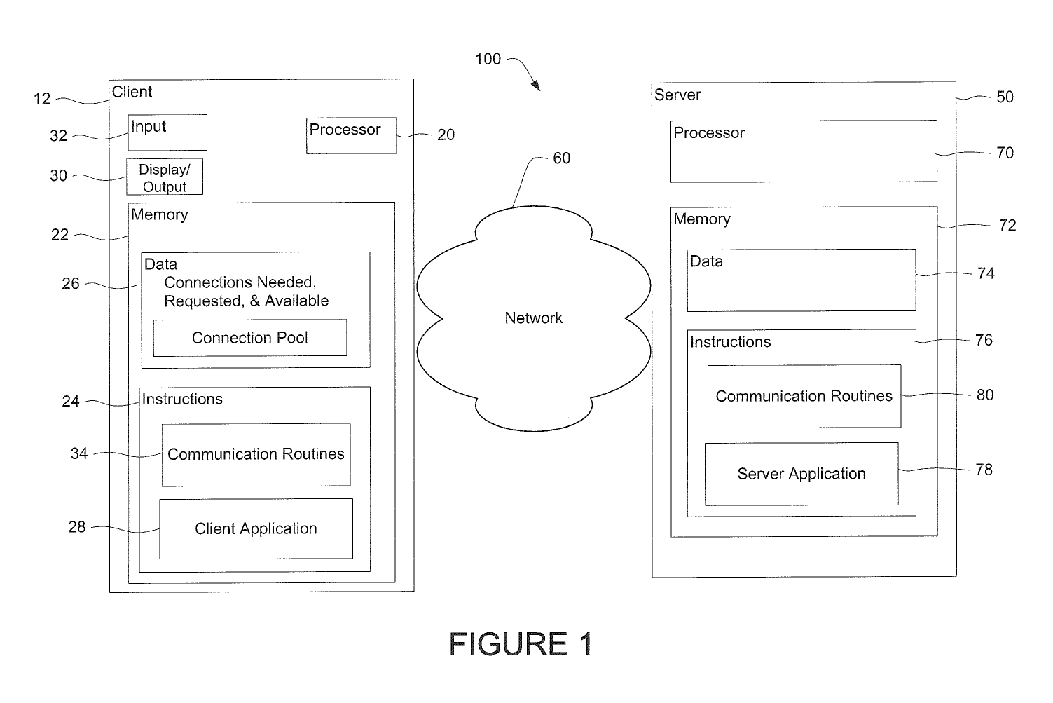

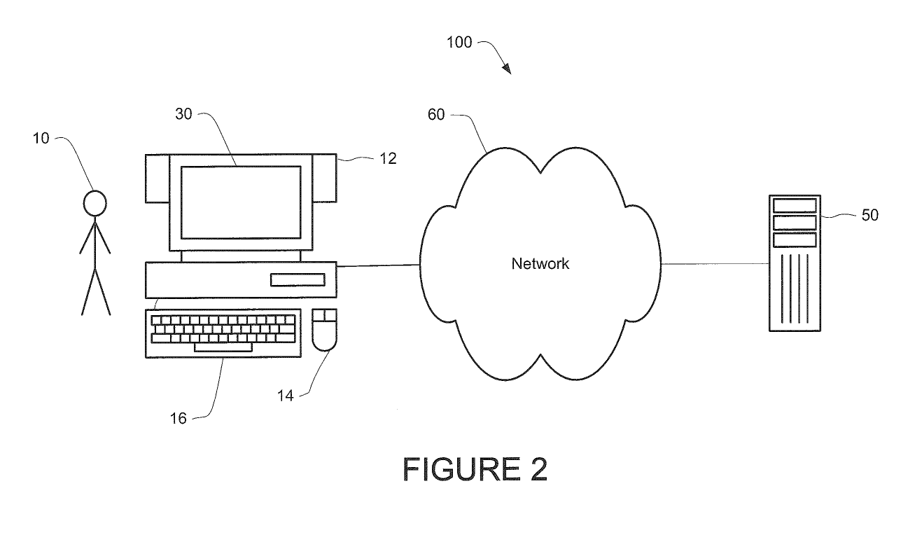

Referring to FIGS. 1-2, a communication system 100 in accordance with one aspect of the invention may provide for exchange of data between a client computer 12 and a server computer 50 over a communication network 60. The client computer 12 contains a processor 20, memory 22 and other components typically present in general purpose computers. In addition, the server 50 contains a processor 70 and a memory 72.

The memory 22 stores information accessible by the processor 20, including instructions 24 that may be executed by the processor 20 and data 26 that may be retrieved, manipulated or stored by the processor 20. Similarly, the memory 72 stores information accessible by processor 70, including instructions 76 that may be executed by the processor 70 and data 74 that may be retrieved, manipulated or stored by the processor 70. The memory may be of any type capable of storing information accessible by the processor, such as a hard-drive, memory card, ROM, RAM, DVD, CD-ROM, write-capable, read-only memories.

The processors 20, 70 may comprise any number of well known processors, such as processors from Intel Corporation. Alternatively, the processors may be a dedicated controller such as an ASIC.

The instructions 24, 76 may comprise any set of instructions to be executed directly (such as machine code) or indirectly (such as scripts) by the processors 20, 70, respectively. In that regard, the terms “instructions,” “steps” and “programs” may be used interchangeably herein. The instructions may be stored in object code form for direct processing by the processor, or in any other computer language including scripts or collections of independent source code modules that are interpreted on demand or compiled in advance. The functions, methods and routines of instructions in accordance with the present invention are explained in more detail below.

The data 26, 74 may be retrieved, stored or modified by the processors 20, 70 in accordance with the instructions 24, 76, respectively. The data may be stored as a collection of data. For instance, although the invention is not limited by any particular data structure, the data may be stored in computer registers, in a relational database as a table having a plurality of different fields and records, XML documents, or flat files. The data may also be formatted in any computer readable format such as, but not limited to, binary values, ASCII or EBCDIC (Extended Binary-Coded Decimal Interchange Code). Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIG. 1 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one embodiment, the client computer 12 may be a general purpose computer, intended for use by a person, having all the internal components normally found in a personal computer such as a central processing unit (CPU), display 30, input 32 such as a CD-ROM drive, mouse, keyboard or microphone, and a hard-drive, speakers, modem and/or router (telephone, cable or otherwise) and all of the components used for connecting these elements to one another. Moreover, computers 50, 12 in accordance with the systems and methods described herein may comprise any device capable of processing instructions and transmitting data to and from humans and other computers, including network computers lacking local storage capability, PDAs with modems and Internet-capable wireless phones. Although the only input means shown in FIG. 2 are the mouse 14 and keyboard 16, other means for inputting information from a human into a computer are also acceptable such as a microphone, touch-sensitive screen, voice recognition, etc.

The server 50 and the client computer 12 are capable of direct and indirect communication, such as over the network 60. Although only a single client computer and a single server are depicted in FIGS. 1 and 2, it should be appreciated that a typical system can include a large number of connected computers and several servers to which the computers can connect, with each different computer being at a different node of the network. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks cards and wireless interfaces.

In one aspect of the invention, instructions 76 in server 50 may include a web-server application 78 that receives and services requests for information in accordance with one or more network protocols from other devices over the network. The requests serviced by the web-server may be any type of request, such as a request for a connection to the server, a request for a network address of a device, or a request for other resources hosted by the server such as a web-page, an image, or any other data. The network protocols may include the TCP/IP protocol suite or any other network protocol that enables communications between devices over the network. In addition to servicing requests received at the server, the web-server application 78 may also transmit requests and information from the server 50 to other devices over the network.

Instructions 76 may also include, as part of the web-server application or as a separate application or routine, one or more communication routines 80 that assist in the receipt and transmission of the information from the server to other devices over the network. For example, the web-server application 78 may use communication routines 80 to place a resource hosted by the server (e.g., web-page) into the data portion of one or more data packets and to transmit the data packets to the client device in accordance with a network protocol (e.g., TCP). In this regard, the functions of sending, receiving and processing the data packets may be also be accomplished using communication routines provided by operating systems such as Linux and Microsoft Windows. In addition, while particularly advantageous when used in connection with web-servers, it will be understood that the system and method is not limited to any particular application.

Data 74 in the server 50 may include any data, such as requests for information received from the client 12 over network 60 and may also include the resources or information responsive to client's requests.

Similarly, instructions 24 in client 12 may include a web-browser application 28. The web-browser application 28 may accept input entered by a user into the web-browser, such as a request for a resource hosted by the server 50 on the network. By way of example, a user may enter a Uniform Resource Locator (URL) into the web-browser 28 that identifies the location and method of retrieving a resource such as a web-page, an image, or other data available at server 50. The web-browser 28 may parse and process the information in the URL to identify the server hosting the information desired by the user, to request a connection to the identified server, and to request the desired resource from the server. The web-browser may also format and display, to the user, any data received from the server in response to the user's request, as part of one or more web-pages.

Instructions 24 may also include, as part of the web-browser or as a separate application or routine, one or more communication routines 34 that assist in the receipt and transmission of the information from the client to other devices in accordance with one or more network protocols. For example, the web-browser 28 may use communication routines 34 for transmitting, to the server 50, a request for a connection to the server, a request for a network address of another server, or a request for a web-page or other resource hosted by the server, and may also use the communication routines 34 for receiving any information transmitted by the server 50 to the client over the network. In this regard, the functions of sending, receiving and processing information over the network may be also be accomplished using communication routines provided by operating systems such as Linux and Microsoft Windows.

Data 26 in the client 12 may include any data, such as requests for information to be transmitted over network 60 to the server 50, and may also include the resources responsive to the client's requests or any other information received from the server.

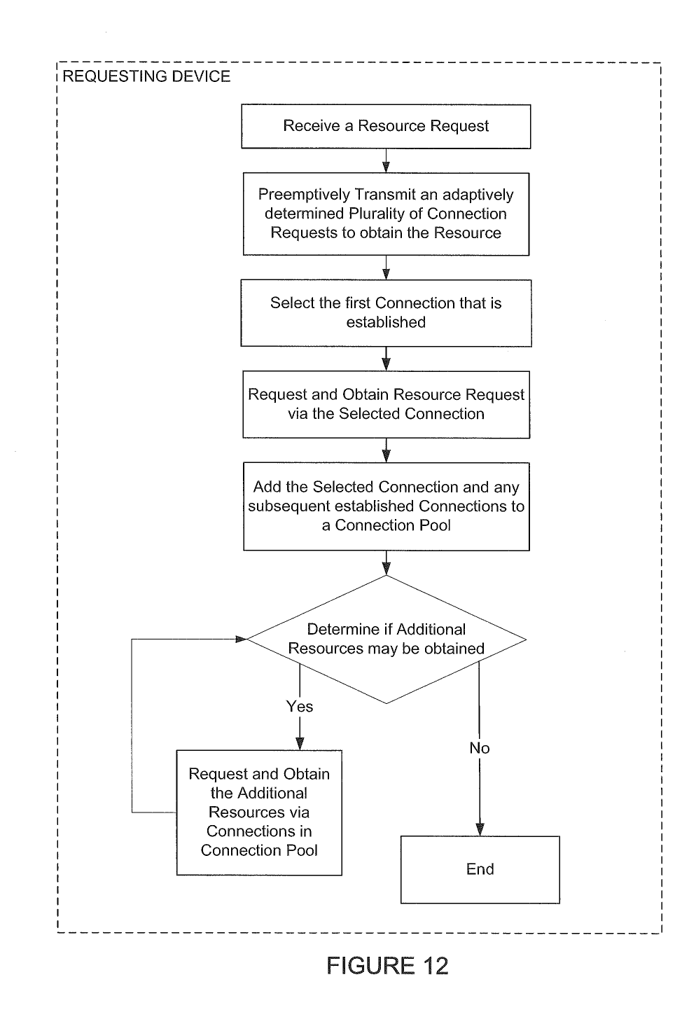

An exemplary operation in accordance with the process shown in FIG. 12 and various aspects of the invention follows below. It should be understood that the following operations do not have to be performed in the precise order described below. Rather, various steps can be handled in reverse order or simultaneously.

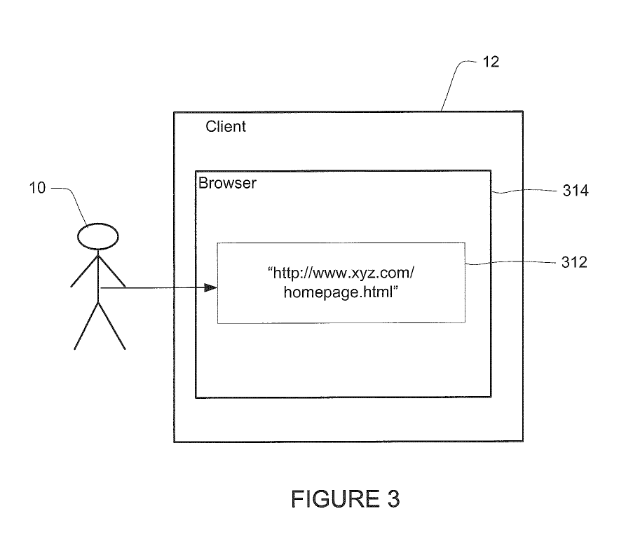

In accordance with one aspect of the system and method provided herein and as illustrated in FIG. 3, a user 10 at client device 12 may input a request in the form of URL 312 into the web-browser 314 that identifies a network resource desired by the user. The web-browser 314 may parse URL 312 to determine the location and method for obtaining the desired resource. For example, the web-browser 314 may parse URL 312 and determine that the resource desired by the user is the web-page “homepage.html” that may be obtained using from a server associated with the address “www.xyz.com” using the hyper text transport protocol “HTTP”.

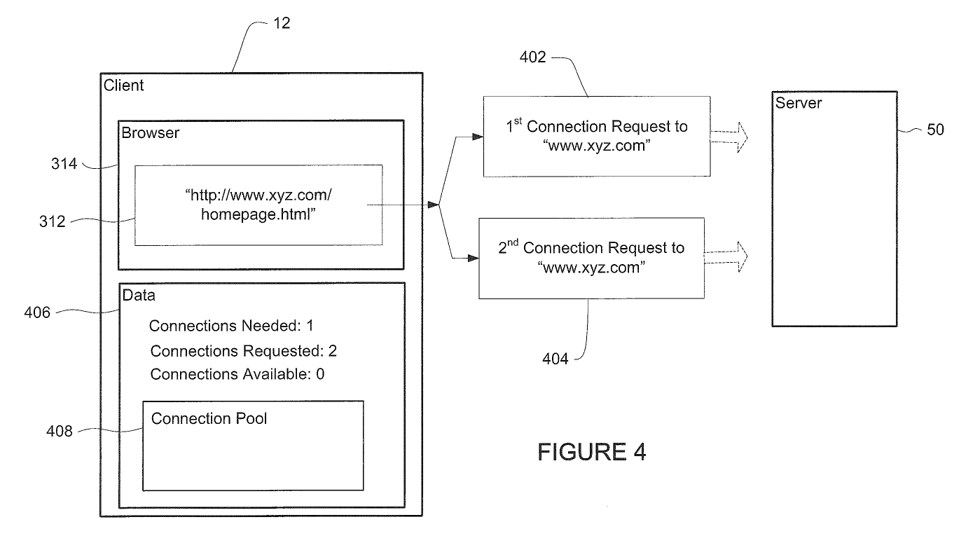

To service the user's request, the web-browser application 314 may preemptively transmit, from the application layer, an adaptively determined plurality of connection requests to the server hosting the resource desired by the user, where the number of connection requests transmitted to the server is greater than the number necessary to obtain the desired resource. For example, and as illustrated in FIG. 4, web-browser 314 may generate and preemptively transmit two requests 402, 404 requesting a connection to server 50, even though only a single connection is necessary to obtain the web-page “homepage.html” desired by the user.

In addition, the web-browser 314 may maintain data indicating the number of connections that are necessary, requested, and available. For example, the web-browser 314 may maintain data 406 that indicates that the number of connections needed to obtain the desired resource is one, the number of connections that have been requested is two, and the number of connections currently available is zero. In addition, data 406 may also contain a connection pool 408, which may be used to add and maintain connection information specific to a connection that has been established between the client and the server. As described further below, once a connection is established, it may be added to the connection pool 408 and used to communicate information with the server.

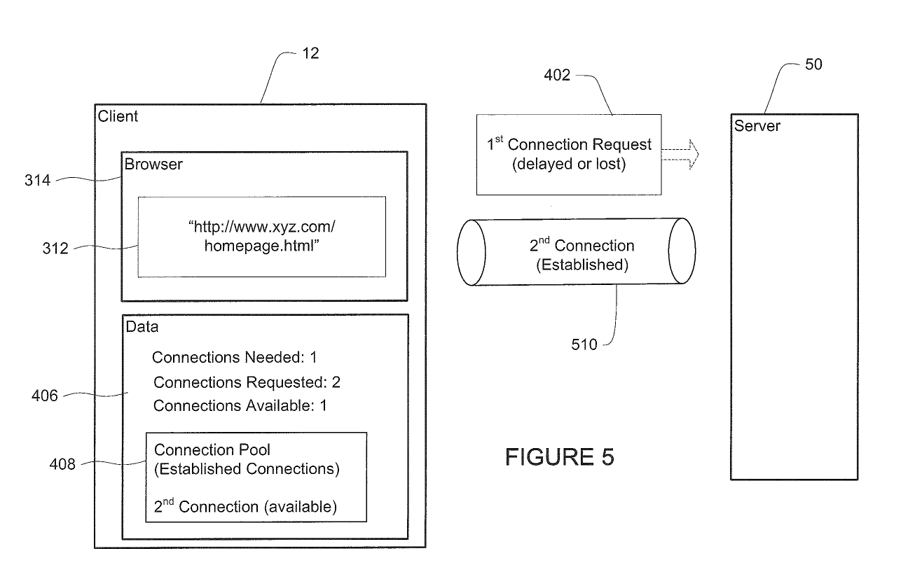

In some cases, preemptively transmitting an adaptively determined plurality of connection requests to obtain a single resource from the server over the network may reduce latency where one or more, but not all, of the transmitted connection requests is delayed or lost en route to the server. For example and as illustrated in FIG. 5, in certain network conditions the 1^{st} connection request 402 may be delayed (or even lost) en route to the server 50, but not the preemptively transmitted 2^{nd} connection request, which may be received at the server 50 in a relatively timely manner. In such cases, because the preemptively transmitted 2^{nd} connection request 404 is received at the server, a second connection 510 (responsive to the 2^{nd} connection request 404), may be established between the client 12 and the server 50 prior to the establishment of a 1^{st} connection in response to the 1^{st} connection request 402 (which, as indicated earlier, may be lost or delayed). In addition, even if the 1^{st} connection request 402 is eventually received at the server, preemptively transmitting the 2^{nd} connection request 404 may, in certain network conditions, result in the 2^{nd} connection 510 being established relatively much earlier than if solely the 1^{st} connection request 402, but not the 2^{nd} connection request 404, had been transmitted from the client to the server. Thus, upon establishment of the 2^{nd} connection 510 as described above, the web-browser application 314 may add the 2^{nd} connection 510 to the connection pool 408 and update data 406 to indicate that the number of connections available is now one.

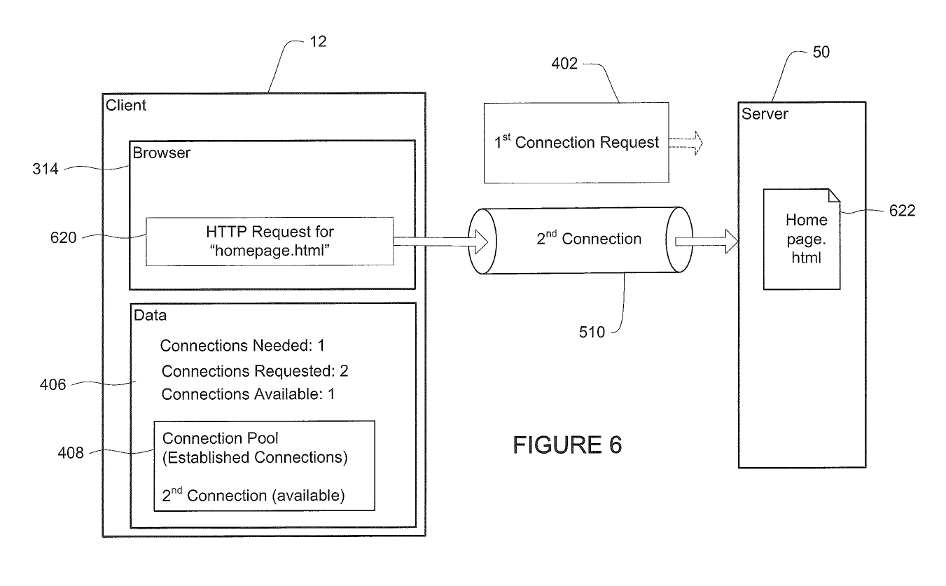

Once a connection between the client and the server is available (i.e., established), the web-browser may use the available connection to communicate with the server. For example, and as shown in FIG. 6, the web-browser application 314 may transmit, via the available 2^{nd} connection 510 in connection pool 408, an HTTP request 620 to the server 50 for the desired web-page 622 (“homepage.html”) hosted by the server.

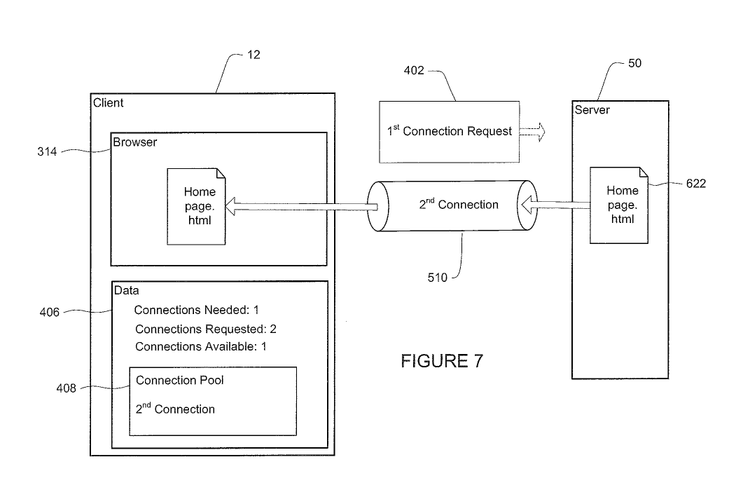

As shown in FIG. 7, server 50, upon receiving the HTTP request 620 from the client 12 over the 2^{nd} connection 510, may transmit the desired web-page 622 back to the client using the same 2^{nd} connection 510. Once received at the client, the web-browser 314 may display some or all of the content in the web-page 622 to the user 10.

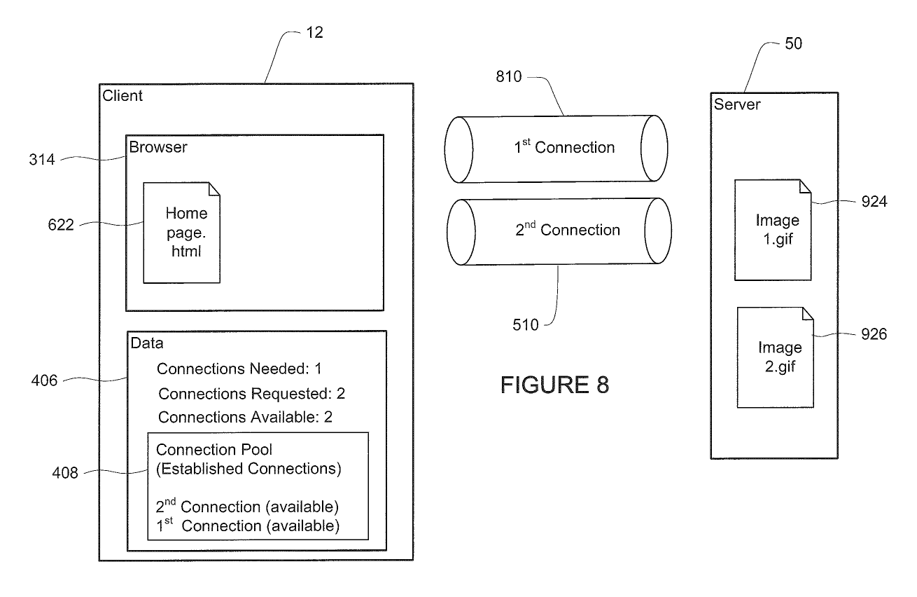

Sometime during or after the process described above, the server 50 may finally receive and respond to the delayed 1^{st} connection request 402 transmitted by the client 12. As illustrated in FIG. 8, the server's response may now result in the completion of the three-way handshake and the establishment of the 1^{st} connection 810 between the client and the server. As before, the web-browser application 314 may add the now available 1^{st} connection 810 to the connection pool 408, and update data 406 to indicate that there are now two connections available for communicating with the server 50.

Once established, client 12 may use both connections, i.e. the 1^{st} connection 810 and the 2^{nd} connection 510, for requesting additional resources from the server 50 over the network. In this regard, the additional resources may be identified by a resource already available at the client. For example, in many cases web-pages such as the web-page 622 received from the server 50 may contain one or more links to additional resources, such as images or other data that are available at the server and may be requested by the client.

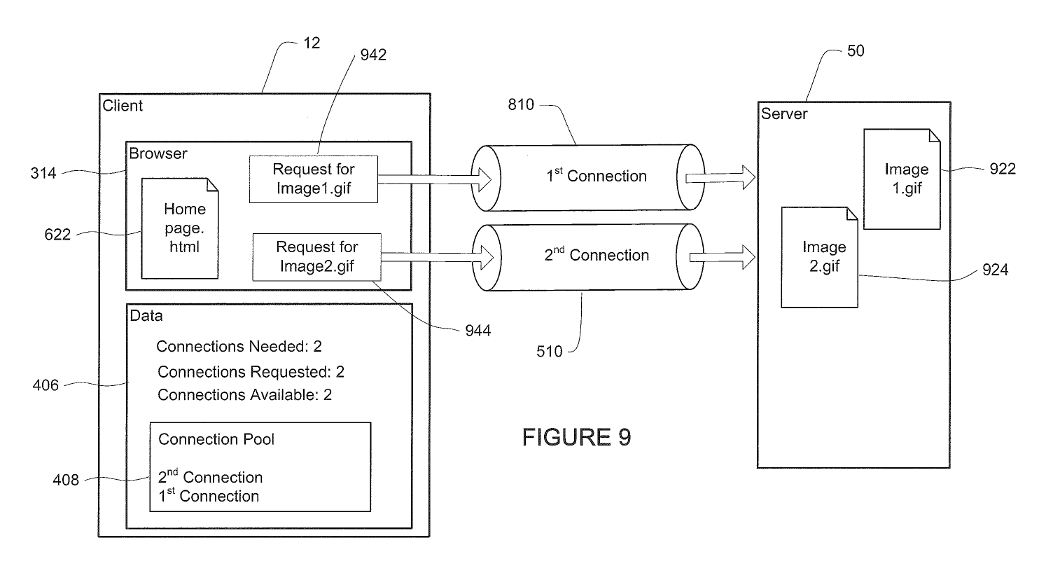

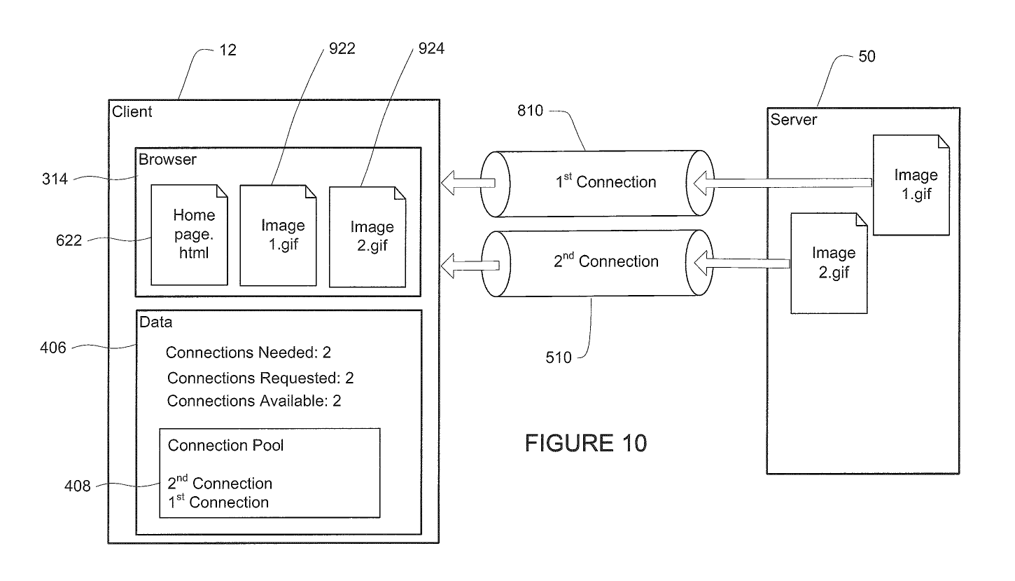

In such cases, the client 12 may use the one or more established and available connections in connection pool 408 for obtaining additional resources from the server 50. By way of example and as shown in FIG. 9, the web-browser 314 may determine that the resource “homepage.html”, received from the server 50, contains links to two additional resources 922 (“image1.gif”) and 924 (“image2.gif”) that may also be requested from the server. Upon such determination, the web-browser 314 may update data 406 to indicate that two connections are now needed to simultaneously transmit requests for each additional resource, and may then transmit a separate request 942, 944 for each of the resources 922, 924 using the connections 510 and 810 that are available in connection pool 408. In response, and as shown in FIG. 10, the server may then provide “image1.gif” and “image2.gif” to the web-browser using the same connections.

The number of requests that are preemptively transmitted from the client device to the server device may be adaptively determined in several ways. In one aspect, the number of requests transmitted may be adaptively determined based on analyzing prior data collected with respect to similar previous requests for one or more desired resources that were transmitted to a specific network node (e.g., server 50).

Alternatively, in another aspect the number of requests transmitted may be adaptively determined based on analyzing the prior data collected in connection with previous requests transmitted to several nodes (e.g., multiple servers). For example, the number of requests may be determined based on an average or typical number calculated from previous requests to all servers, a majority of the servers, or even a server that is different from the server to which a new request is to be transmitted. Further in this regard, the client device may store a running average of the typical number of requests that are transmitted to various servers over a period of time in order to obtain one or more desired resources, and use the running average as the starting value for determining the number of requests that are transmitted to a particular server.

In a yet another aspect, the number of requests that are transmitted may be determined based on the Round Trip Time, commonly known as the RTT time, of the network. The RTT time may be specific to the server 50, or may be an average RTT time based on general current network conditions. The client device may then adaptively choose the number of requests to transmit to the server based upon the RTT time to the server and/or the estimated condition of the network.

In still another aspect, the number of the preemptive requests that are transmitted along with the initial request may be determined based on prior data with respect to the type or identity of a particular resource that is desired. For example, the client device may analyze prior data to determine the type and identity of resource (e.g., a news web-page on server 50), and further determine that it typically contains links to a certain number of additional resources or sub-resources (e.g., images). The client device may then estimate and choose the number of preemptive requests based on the anticipated number of additional resources.

Moreover, the number of requests that are transmitted may also be determined based on various combinations of the foregoing.

Thus, adaptively determining and preemptively requesting more connections than are necessary to obtain a particular resource may reduce the latency measured from the user's perspective in several ways.

First, in many cases the effect on latency caused by the loss or delay of a single connection request may be reduced by preemptively transmitting an initial request and one or more additional requests as described above, which may result in an earlier establishment of a connection between the client and the server and earlier delivery of the desired resource to the user than only if a single request had been transmitted.

Moreover, the system and method described herein may be implemented in an application at the application layer and distinct from the non-application layer functionality provided by the typical lower layers of conventional networking protocols (e.g., transport, internet, or link layers). While certain layers of conventional protocols such as the transport layer of the TCP/IP protocol provide a mechanism for retransmitting the original connection request after determining that the original request has been lost, such mechanisms do not preemptively transmit additional requests. In addition, such conventional protocols can actually increase latency by waiting for a relatively large prescribed period of time to expire (which in some cases may be as much as 3 seconds or more) before determining that the initial and original connection request has been lost and must be retransmitted.

Thus, in one aspect an application such as the web-browser application running on the client device may define and maintain a timeout window, where the timeout window is set to a prescribed timeframe that one or more network protocols will wait before retransmitting an original connection request. In accordance with this aspect, the web-browser application may also preemptively transmit, from the client device to the server device, at least one additional request in addition to the original request to obtain the desired resource, where the at least one additional request is transmitted prior to receiving a reply to the original request from the server device and prior to the expiration of the prescribed timeframe set by the timeout window.

Second, adaptively determining the number of requests to be transmitted as described above and adding the connections as they become available to a connection pool for future use may also reduce latency by allowing requests for multiple additional resources to be transmitted to the server earlier, i.e., without having to request and wait for more connections to be established to obtain such additional resources.

Third, by preemptively requesting and establishing a plurality of connections, but NOT transmitting an actual request more than once, some embodiments may avoid unnecessary consumption of network resources. For example, although more than one initial connection may be preemptively established with a web server, only one request for a specific page may be made over one of such preemptively established connections, such as by using the first connection to become available.

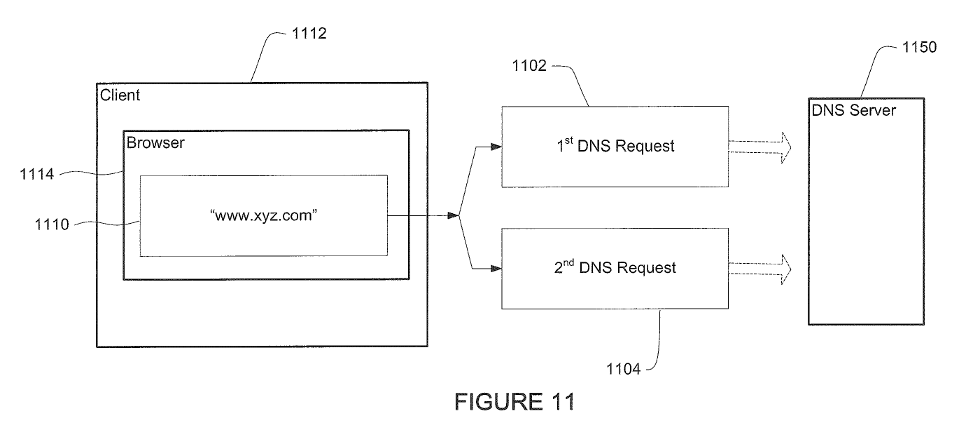

While the exemplary embodiments have illustrated transmitting connection requests, the invention is not limited to any particular type of request. In another aspect of the invention, the type of request transmitted may be, for example, a Domain Name System (DNS) request transmitted to a domain name server in accordance with a domain name resolution protocol. In accordance with this aspect, a requesting device may adaptively determine and preemptively transmit a multiple number of DNS requests to a domain name server, even though only a single DNS request may be necessary to obtain a desired resource, i.e., an IP address of a network device. For example, and as shown in FIG. 11, web-browser 1114 in client 1112 may transmit 1^{st} DNS Request 1102 and second DNS request 1104 to server 1150, to resolve the IP address of the server associated with the URL address 1110 (“www.xyz.com”). As described above with respect to connection requests, preemptively transmitting 1^{st} and 2^{nd} DNS requests instead of only a single DNS request may, in some cases, reduce latency caused by the loss or delay of one of requests, resulting in earlier resolution of an IP address of the server identified in the URL.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for transmitting a request from one node of a network to another node of the network, the method comprising:
receiving, at an initiation node, a resource request for a desired resource hosted at a destination node;
adaptively determining, with a processor, a plurality of connection request packets, and preemptively transmitting the plurality of connection request packets from the initiation node to the destination node to obtain the desired resource;
establishing, in accordance with a first network protocol, one or more connections between the initiation node and the destination node, the one or more connections being established based on respective response packets from the destination node to one or more of the preemptively transmitted plurality of connection request packets, the one or more established connections including a first established connection established prior to any other established connections;
automatically selecting, at the initiation node, the first established connection to the destination node and adding the first established connection to a pool of usable connections;
transmitting the resource request to the destination node via the first established connection.

2. The method of claim 1, further comprising:
receiving, from the destination node, first data responsive to the resource request via the first established connection;
adding, at the initiation node, at least one additional established connection to the pool of usable connections, the at least one additional established connection established after the first established connection; and,
requesting and receiving, after the first data is received, second data and third data from the destination node, the second and third data requested and received via the first established connection and the at least one additional established connection respectively.

3. The method of claim 1, wherein the first network protocol comprises a TCP/IP protocol.

4. The method of claim 1 wherein upon receipt of the resource request at the initiation node, the method further comprises preemptively transmitting, in accordance with a second network protocol, an adaptively determined plurality of address resolution requests to a domain name server to obtain a network address of the destination node.

5. The method of claim 4, wherein the second network protocol comprises a domain name resolution protocol.

6. The method of claim 1, wherein the resource request comprises a URL.

7. The method of claim 1, wherein each of the one or more connections is a TCP connection between the initiation node and the destination node.

8. The method of claim 1, wherein the plurality of connection request packets are adaptively determined based on an analysis of data collected with respect to previous requests transmitted by the initiation node to the destination node.

9. The method of claim 1, wherein the plurality of connection request packets are adaptively determined based on an analysis of data collected with respect to a previous request for the desired resource transmitted by the initiation node to the destination node.

10. A method for transmitting data from one node of a network to another node of the network, the method comprising:
receiving, at an initiation node, a resource request for a desired resource hosted at a destination node;
transmitting a first request, from the initiation node to the destination node over the network, to obtain the desired resource;
defining, at the initiation node, a timeout window with a processor, the timeout window being associated with the transmission of the first request and setting a maximum timeframe, in accordance with a network protocol, for receiving a first reply from the destination node responsive to the first request; and,
preemptively transmitting, from the initiation node to the destination node over the network, at least one additional request to obtain the desired resource, wherein the at least one additional request is transmitted to the destination prior to receiving the first reply at the initiation node and prior to expiration of the maximum timeframe set by the timeout window.

11. A system for transmitting data over a network, the system comprising:
a memory storing instructions and data, the data comprising a resource request for a desired resource hosted at a destination node;
a processor to execute the instructions and to process the data; wherein the instructions comprise:
adaptively determining, with the processor, a plurality of connection request packets, and preemptively transmitting the plurality of connection request packets from an initiation node to the destination node to obtain the desired resource;
establishing, in accordance with a first network protocol, one or more connections between the initiation node and the destination node, the one or more connections being established based on respective response packets from the destination node to one or more of the preemptively transmitted plurality of connection request packets, the one or more established connections including a first established connection established prior to any other established connections;
automatically selecting, at the initiation node, the first established connection to the destination node and adding the first established connection to a pool of usable connections;
transmitting the resource request to the destination node via the first established connection.

12. The system of claim 11, wherein the instructions further comprise:
receiving, from the destination node, first data responsive to the resource request via the first established connection;
adding, at the initiation node, at least one additional established connection to the pool of usable connections, the at least one additional established connection established after the first established connection; and,
requesting and receiving, after the first data is received, second data and third data from the destination node, the second and third data requested and received via the first established connection and the at least one additional established connection respectively.

13. The system of claim 11, wherein the first network protocol comprises a TCP/IP protocol.

14. The system of claim 11, wherein the instructions further comprise preemptively transmitting, in accordance with a second network protocol, an adaptively determined plurality of address resolution requests to a domain name server to obtain a network address of the destination node.

15. The system of claim 14, wherein the second network protocol comprises a domain name resolution protocol.

16. The system of claim 11, wherein the resource request comprises a URL.

17. The system of claim 11, wherein each of the one or more connections is a TCP connection between the initiation node and the destination node.

18. The system of claim 11, wherein the plurality of connection request packets are adaptively determined based on an analysis of data collected with respect to previous requests transmitted by the initiation node to the destination node.

19. The system of claim 11, wherein the plurality of connection request packets are adaptively determined based on an analysis of data collected with respect to a previous request for the desired resource transmitted by the initiation node to the destination node.

20. A system comprising:
a memory storing instructions and data, the data comprising a resource request for a desired resource hosted at a destination node;
a processor to execute the instructions and to process the data; wherein the instructions comprise:
transmitting a first request, from the initiation node, to the destination node to obtain the desired resource;
defining, at the initiation node, a timeout window with a processor, the timeout window being associated with the transmission of the first request and setting a maximum timeframe, in accordance with a network protocol, for receiving a first reply from the destination node responsive to the first request; and,
preemptively transmitting, from the initiation node to the destination node, at least one additional request to obtain the desired resource, wherein the at least one additional request is transmitted to the destination prior to receiving the first reply at the initiation node and prior to expiration of the maximum timeframe set by the timeout window.
